(19) United States
(12) Patent Application Publication
(10) Pub. No.: US 2023/0106343 A1
(43) Pub. Date: Apr. 6, 2023

(54) WATER TREATMENT SYSTEM, CONTROL DEVICE, WATER TREATMENT METHOD, AND PROGRAM

(71) Applicant: ORGANO CORPORATION, Tokyo (JP)

(72) Inventor: Keiichiro FUKUMIZU, Tokyo (JP)

(73) Assignee: ORGANO CORPORATION, Tokyo (JP)

(21) Appl. No.: 17/910,173

(22) PCT Filed: Feb. 16, 2021
(86) PCT No.: PCT/JP2021/005755

§ 371 Date: Sep. 8, 2022

(30) Foreign Application Priority Data
Mar. 17, 2020 (JP) 2020-046476

(51) Int. Cl. G06V 20/50; G06V 10/20; G06V 10/75; G06V 10/44; C02F 1/52; C02F 1/68

(52) U.S. Cl. CPC G06V 20/50; G06V 10/20; G06V 10/751; G06V 10/44; C02F 1/5209; C02F 1/685; C02F 2209/006

(57) ABSTRACT

The present application includes a tank into which water to be treated flows, an imaging device for capturing an image of water into which coagulant has been added and that is stored in the tank, and a control device for performing grayscale processing of the image captured by the imaging device, performing differential processing of the image subjected to the grayscale processing, and determining the state of the aggregate in the water based on the feature value calculated from the result of performing differential processing.

### TECHNICAL FIELD

The present invention relates to a water treatment system, a control device, a water treatment method and a program.

### BACKGROUND OF ART

In water works, a sewage treatment plant, or other waste water treatment facility, a treatment is performed in which a coagulant is added to water to be treated, suspended solid (SS) in the water to be treated are aggregated to form flocs, and the flocs are separated by precipitation separation, floatation separation, or the like. In doing so, for example, a technique has been considered in which a coagulant is added into raw water which is water to be treated and stirred, and the coagulant dosage is determined based on an optical measurement value obtained by irradiating the stirred water with light (see, for example, Patent Document 1)

### PRIOR ART DOCUMENTS

### Patent Documents

[Patent Document 1] JP 2017-121601 JP

### SUMMARY OF THE INVENTION

### Problem to be Solved by the Invention

In the technique as described in Patent Document 1, the state of the raw water is determined using the transmitted light intensity as an optical measurement value. Therefore, there is a problem that it is impossible to accurately determine the state of water in the tank by the light source and the dirt of the wall surface of the tank.

It is an object of the present invention to provide a water treatment system, a controller, a water treatment method and a program which can more accurately determine the state of water in the tank.

### A means for solving the problem

The present invention is a water treatment system, comprising:

a tank into which water to be treated flows,

an imaging device that captures an image of water into which coagulant has been added and that is stored in the tank, and

a control device that performs a grayscale processing of an image captured by that the imaging device, and a differential processing of the image that was subjected to the grayscale processing and that determines a state of the aggregates in the water based on a feature value calculated from the result of performing the differential processing.

Preferably, the control device performs a process of digitizing the grayscale of the image captured by the imaging device into three or more gradations as the grayscale processing.

Preferably, the water treatment system further comprises:

an addition device that injects the coagulant into the water to be treated,

wherein

the control device generates a control signal for controlling the addition of the coagulant based on the feature value and transmits the generated control signal to the addition device, and

the addition device controls the addition of the coagulant based on the control signal transmitted from the control device.

Preferably, the control device compares the feature value with a preset threshold value and generates the control signal based on the result of the comparison.

Preferably, the control device calculates from the result of performing the differential processing the number of edge pixels or a numerical value obtained based on the number of edge pixels as the feature value.

Preferably, the imaging device is an infrared sensor.

The present invention is a control device, comprising:

a grayscale processing unit that performs grayscale processing of an image captured by an imaging device of water stored in a tank,

a differential processing unit that performs differential processing for the image that has been subjected to grayscale processing by the grayscale processing unit, and

a determination unit that calculates a feature value based on the result of performing the differentiation processing and that determines the state of the aggregate in the water based on the calculated feature value.

Preferably, the grayscale processing unit performs a process of digitizing the grayscale of the image captured by the imaging device into three or more gradations as the grayscale processing.

Preferably, the control device further comprises:

a control signal generator that generates a control signal for controlling the addition of coagulant into the water stored in the tank based on the feature value calculated by the determination unit, and

a transmission unit that transmits the control signal generated by the control signal generator to an addition device that injects the coagulant into water to be treated.

The present invention is a water treatment method, comprising:

a process for capturing an image of water into which coagulant has been added and that is stored in a tank into which water to be treated flows,

a process for performing grayscale processing of the captured image,

a process for performing differential processing of the image that has been subjected to the grayscale processing,

a process for calculating a feature value based on the result of performing the differential processing, and

a process for determining a state of an aggregate in the water based on the calculated feature value.

Preferably, the grayscale processing is a process of digitizing the grayscale of the captured image into three or more gradations.

Preferably, the water treatment method further comprises:

a process for generating a control signal for controlling addition of the coagulant based on the calculated feature value, and

a process for transmitting the generated control signal to an addition device for injecting the coagulant into water to be treated.

The present invention is a program to make a computer execute procedures, the procedures comprising:

a procedure for performing grayscale processing of an image captured by an imaging device of water stored in a tank,

a procedure for performing differential processing of the image that has been subjected to the grayscale processing,

a procedure for calculating a feature value based on the result of performing the differential processing, and

a procedure for determining a state of an aggregate in the water based on the calculated feature value.

Preferably, the grayscale processing is a process of digitizing the grayscale of the captured image into three or more gradations.

Preferably, the program further comprises:

a procedure for generating a control signal for controlling an addition of coagulant into the water stored in the tank based on the calculated feature value, and

a procedure for transmitting the generated control signal to an addition device for injecting the coagulant into water to be treated.

### Advantageous Effects of the Invention

In the present invention, it is possible to more accurately determine the state of water in the tank.

### BRIEF DESCRIPTION OF THE DRAWINGS

FIG. 1 is a diagram showing a first embodiment of the water treatment system of the present invention.

FIG. 2 is a diagram showing an example of the internal configuration of control device 200 shown in FIG. 1.

FIG. 3 is a flowchart for explaining an example of a water treatment method in the water treatment system shown in FIG. 1.

FIG. 4 is a diagram showing a second embodiment of the water treatment system of the present invention.

FIG. 5 is a diagram showing an example of the internal configuration of control device shown in FIG. 4.

FIG. 6 is a diagram for explaining an example of the grayscale processing and the differential processing.

FIG. 7 is a diagram for explaining an example of a binarization process and the differentiation process.

FIG. 8 is a flowchart for explaining an example of a water treatment method in the water treatment system shown in FIG. 4.

FIG. 9 is a flow diagram showing a first example of the application of the water treatment system of the present invention.

FIG. 10 is a flow diagram showing a second example of the application of the water treatment system of the present invention.

### DESCRIPTION OF EMBODIMENTS

Embodiments of the present invention will be described below with reference to the accompanying drawings.

### First Embodiment

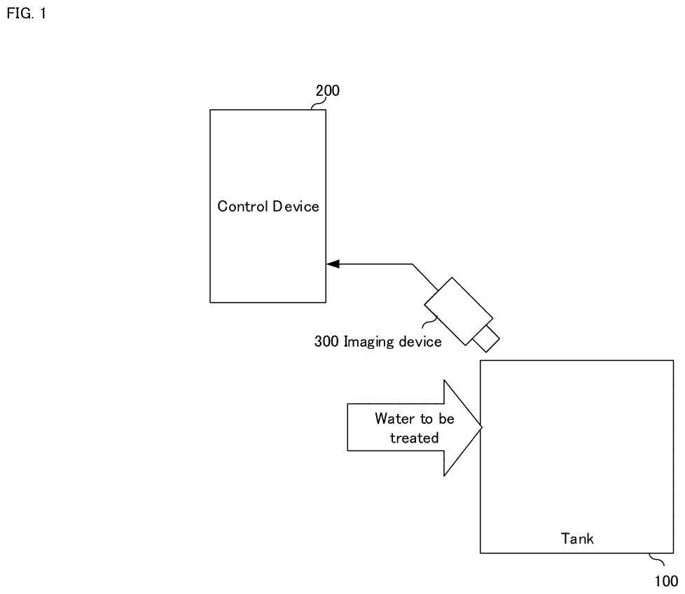

FIG. 1 is a diagram showing a first embodiment of the water treatment system of the present invention. As shown in FIG. 1, the water treatment system in this embodiment has tank 100, control device 200, and imaging device 300.

Tank 100 is a storage tank into which water to be treated, which is raw water, flows and which stores the water to be treated that has flowed in. The water to be treated is not particularly limited as long as it is water containing a suspended substance or a substance to be insolubilized. The water stored in tank 100 is added with a coagulant. Further, a stirring mechanism for stirring the stored water may be provided in tank 100. Imaging device 300 captures an image of the water stored in tank 100 into which the coagulant has been added. Imaging device 300 is, for example, a camera or an image sensor. When an image sensor is used, a color sensor, a monochrome sensor, or an infrared sensor may be used, but it is preferable to use an infrared sensor because control device 200 performs a grayscale process to be described later. Further, if the imaging is impeded by the diffuse reflection of light on the water surface, it is desirable to install a polarizing filter between imaging device 300 and tank 100. The polarizing filter may be, for example, of a type that attaches to the lens of imaging device 300. Control device 200 determines the state of the aggregate based on the image captured by imaging device 300.

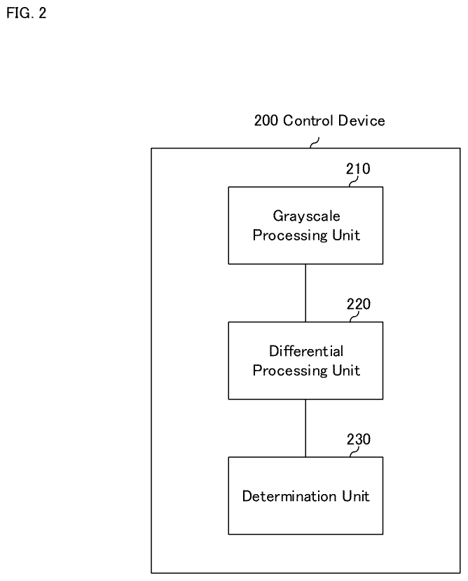

FIG. 2 is a diagram showing an example of the internal configuration of control device 200 shown in FIG. 1. As shown in FIG. 2, control device 200 shown in FIG. 1 has grayscale processing unit 210, differential processing unit 220, and determination unit 230. Incidentally of the components of control device 200 shown in FIG. 1, FIG. 2 shows only the main components relating to the present embodiment.

Grayscale processing unit 210 performs grayscale processing of the image captured by imaging device 300. This grayscale processing is a process of digitizing the grayscale (light and dark) of an image into three or more gradations, for example, 256 gradations (0 to 255 gradations). This shading process is also called a projection process. Differential processing unit 220 performs differential processing of the result that was subjected to grayscale processing by grayscale processing unit 210. Specifically, differential processing unit 220 differentiates the numerical data which is the result of the grayscale processing performed by grayscale processing unit 210. Thus, differential processing unit 220 calculates the ratio of the change of the numerical data (gradation). Determination unit 230 calculates a feature value based on the result of the differential processing performed by differential processing unit 220. Determination unit 230 determines the state of the aggregate based on the calculated feature value.

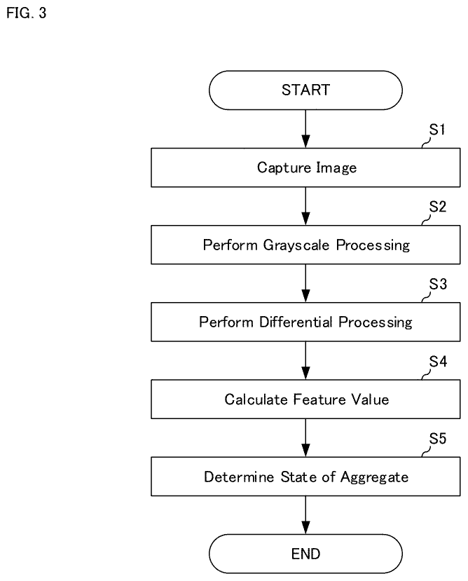

The water treatment method in the water treatment system shown in FIG. 1 will be described below. FIG. 3 is a flowchart for explaining an example of a water treatment method in the water treatment system shown in FIG. 1. Water to be treated as raw water is stored in tank 100, and a coagulant is added into tank 100

First, imaging device 300 captures an image in tank 100, and control device 200 acquires the captured image (Step S1). Grayscale processing unit 210 then performs grayscale processing on the captured image in control device 200 (Step S2). Subsequently, differential processing unit 220 differentiates the numerical data which is the result of the grayscale processing performed by grayscale processing unit 210 (Step S3). Then, differential processing unit 220 calculates a feature value based on the result of the differential processing performed by differential processing unit 220 (Step S4). Incidentally, the processing in Step S4 may be performed by determination unit 230 rather than by differential processing unit 220. Determination unit 230 then determines the state of the aggregate based on the calculated feature value (Step S5).

Thus, control device 200 performs grayscale processing and differential processing of the image of tank 100 that was captured by imaging device 300 and determines the state of the aggregate in tank 100 based on the feature value obtained from the result of the processing. Therefore, it is possible to more accurately determine the state of water in tank 100.

### Second Embodiment

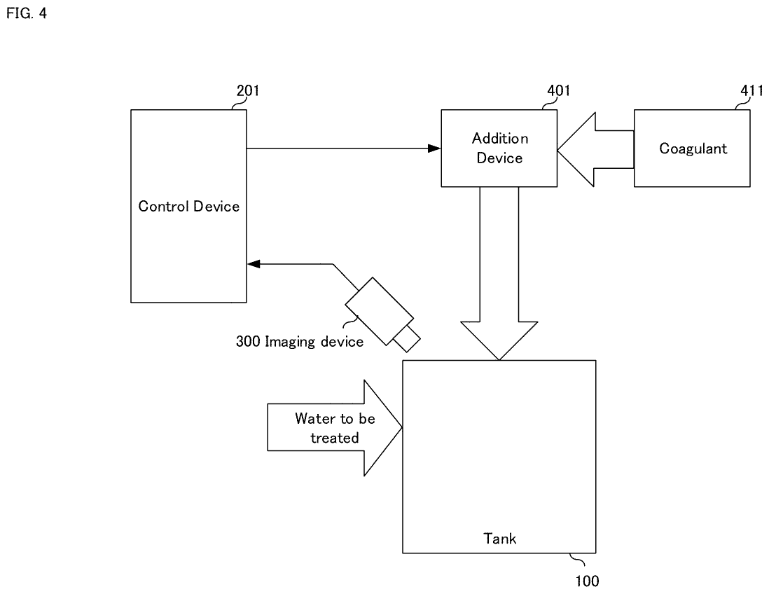

FIG. 4 is a diagram showing a second embodiment of the water treatment system of the present invention. As shown in FIG. 4, the water treatment system in this embodiment has tank 100, control device 201, imaging device 300, and addition device 401. Tank 100 and imaging device 300 are the same as those in the first embodiment.

In addition to the function provided by control device 200 in the first embodiment, control device 201, based on the result of determining the state of the aggregate, transmits a control signal to addition device 401 for controlling the addition of coagulant 411 into tank 100. Addition device 401 injects coagulant 411 into the water stored in tank 100. At this time, addition device 401 controls the addition (addition amount) of coagulant 411 in accordance with the control signal transmitted from control device 201. The addition of coagulant 411 by addition device 401 may be an addition into the water to be treated before the water flows into tank 100.

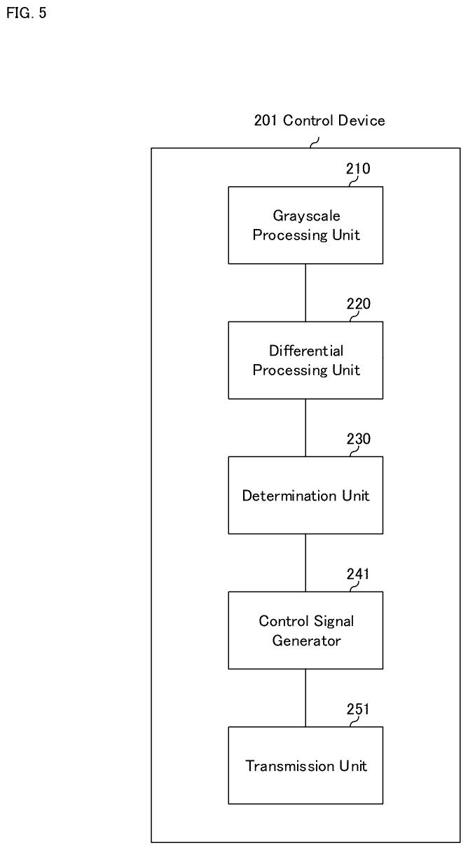

FIG. 5 is a diagram showing an example of the internal configuration of control device 201 shown in FIG. 4. As shown in FIG. 5, control device 201 shown in FIG. 4 includes grayscale processing unit 210, differential processing unit 220, determination unit 230, control signal generator 241, and transmission unit 251. Incidentally, FIG. 5 shows only the main components relating to the present embodiment among the components of control device 201 shown in FIG. 4. Grayscale processing unit 210, differential processing unit 220 and determination unit 230 are each the same as those in the first embodiment. First, the details of the processing of grayscale processing unit 210, differential processing unit 220 and determination unit 230 will be described.

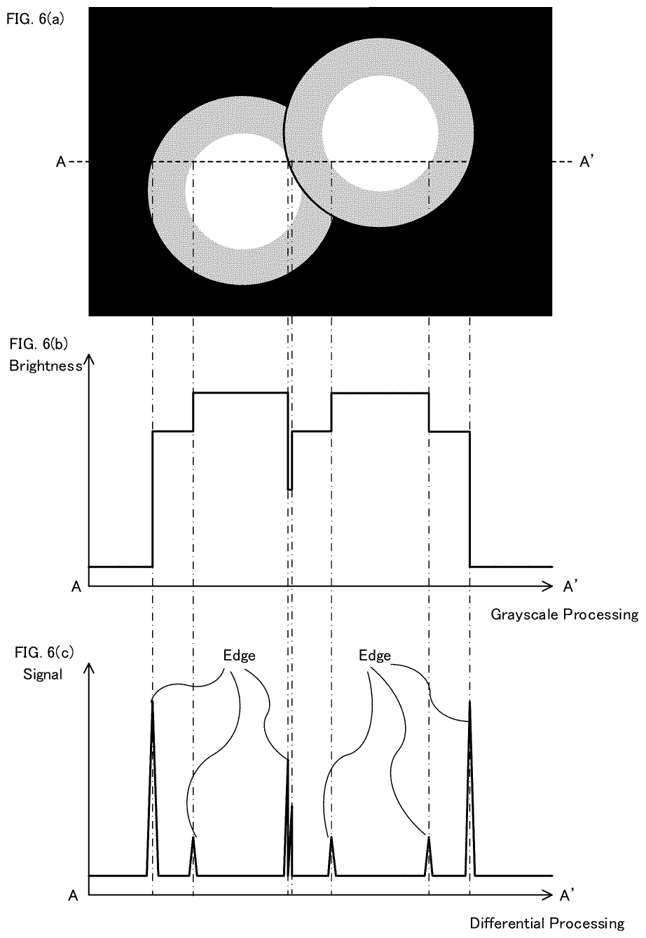

FIG. 6 is a diagram for explaining an example of the grayscale processing and the differential processing. FIG. 6(a) shows an example of an image captured by imaging device 300. In the image shown in FIG. 6(a), two aggregates are present partially overlapping each other. Grayscale processing unit 210 determines the grayscale (brightness) of the image and digitalizes (performs grayscale processing) the grayscale (brightness) of the image. FIG. 6(b) is a diagram showing a graphical digitalization of the grayscale (brightness) along A-A′ of the images shown in FIG. 6(a). As shown in FIG. 6(b), the degrees of brightness (respective brightness) along A-A′ of the image shown in FIG. 6(a) become numerical values corresponding to each degree of brightness and are shown graphically. Differential processing unit 220 performs differential processing based on the numerical values calculated by grayscale processing as shown in FIG. 6(b). In this way, differential processing unit 220 calculates the rate of change (absolute value) of the grayscale (brightness). In other words, differential processing unit 220 detects the change points (edges) of the numerical data of the grayscale (brightness) indicated by the graph. FIG. 6(c) is a graph showing the result of the differential processing performed by differential processing unit 220 on the result the grayscale processing performed by grayscale processing unit 210. As shown in FIG. 6(c), the points of change and the rate of change of the numerical data of grayscale (brightness) have been detected. The signal in FIG. 6(c) shows the rates of change (absolute values) of grayscale (brightness). The differential values become large in places where there are large changes the grayscale, which can be edges. Determination unit 230 may calculate as a feature value the number of pixels of the edges obtained as a result of the differential processing, or may calculate as a feature value the number of pixels of the edge that are equal to or greater than a predetermined change rate. By such processing, it is possible to determine the state of the aggregate using the number of edge pixels as a feature value. Further, determination unit 230 may calculate the feature value by multiplying the number of pixels of the resulting edges of the differential processing (the number of change points of grayscale) by a coefficient corresponding to the magnitude of the rate of change.

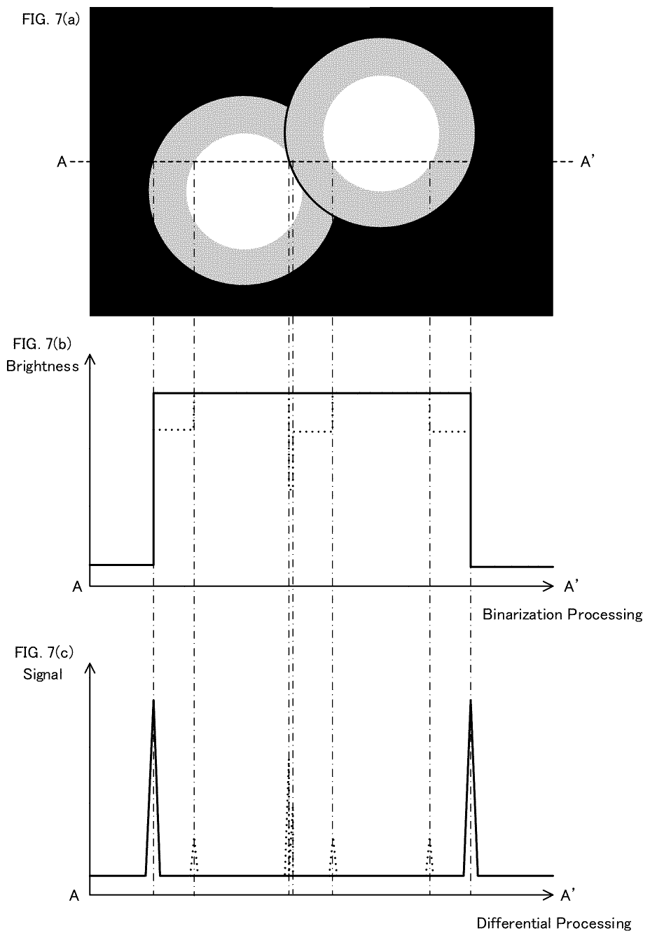

FIG. 7 is a diagram for explaining an example of the binarization process and the differentiation process. FIG. 7(a) shows an example of an image captured by imaging device 300. In the image shown in FIG. 7(a), two aggregates are present partially overlapping each other. FIG. 7(b) is a diagram showing graphically the grayscale (brightness) along A-A′ of the image shown in FIG. 7(a) that has been subjected to binarization processing rather than the above-described grayscale processing. As shown in FIG. 7(b), each of the degrees of shade (each degree of brightness) in A-A′ of the image shown in FIG. 7(a) is binarized based on a magnitude relation with a predetermined threshold value, that is, is digitized into two gradations of white or black, and shown in a graph. FIG. 7(c) is a graph showing the results of performing differential processing of the data of the graph shown in FIG. 7(b). As shown in FIG. 7(c), when the binarization processing is performed, a portion of the change points of the degrees of grayscale (brightness) is not expressed. When an image is captured of aggregate in water, multiple aggregates often overlap each other in the depth direction. As a result, when a binarization processing is used, it is not possible to accurately grasp the state of aggregates in water.

Based on the feature value calculated by determination unit 230, control signal generator 241 generates a control signal for controlling the addition of coagulant 411 into tank 100 by addition device 401. Control signal generator 241 compares the feature value with a preset threshold value and generates a control signal based on the result of the comparison. Control signal generator 241 generates a control signal that includes information indicative of whether addition device 401 is to increase, decrease, or maintain the coagulant dosage 411 added into tank 100. Alternatively, control signal generator 241 generates a control signal indicating a current value or a voltage value, or alternatively, the coagulant dosage to be added. If the control signal is intended to indicate a current value or a voltage value, the current value or voltage value indicated by the control signal is a current value or a voltage value for driving addition device 401. Control signal generator 241 includes, in the control signal, the current or voltage values necessary for addition device 401 to inject the coagulant dosage to be added. That is, addition device 401, by being driven by the current value or the voltage value included in the control signal that is transmitted, is able to add a required amount of coagulant. The result of the comparison between the feature value and the threshold value, as well as information indicating what control signal to create, are set in association in advance. Control signal generator 241 creates a control signal with reference to this association. The signal form of the control signal is not particularly specified. For example, if the feature value exceeds a threshold value, control signal generator 241 generates a control signal indicating a current value or a voltage value such that the amount of the coagulant to be added by addition device 401 is reduced. Further, when the feature value is less than the threshold value, control signal generator 241 generates a control signal indicating a current value or a voltage value such that the coagulant dosage to be added by addition device 401 is increased. Further, when the feature value is the same value as the threshold value, control signal generator 241 generates a control signal indicating a current value or a voltage value such that addition device 401 maintains the amount of the coagulant to be added.

Control signal generator 241 may compare the feature value and a plurality of threshold values. In this case, for example, control signal generator 241 compares the feature value with two threshold values, A and a value B that is a larger value than A. Control signal generator 241 may generate a control signal that controls the addition amounts of a plurality of types of coagulants depending on whether the feature value is less than A, is a value of A or more and less than B, or is B or more.

Transmission unit 251 transmits a control signal generated by control signal generator 241 to addition device 401. This transmission may be wireless or may be wired. Further, the form of connection between control device 201 and addition device 401 may allow bidirectional communication. For example, control device 201 and addition device 401 may be directly connected to each other, or may be connected via a communication network. Transmission unit 251 may cause the flow of current of the current value indicated by the signal generated by control signal generator 241 to addition device 401. Transmission unit 251 may apply the voltage of the voltage value indicated by the signal generated by control signal generator 241 to addition device 401.

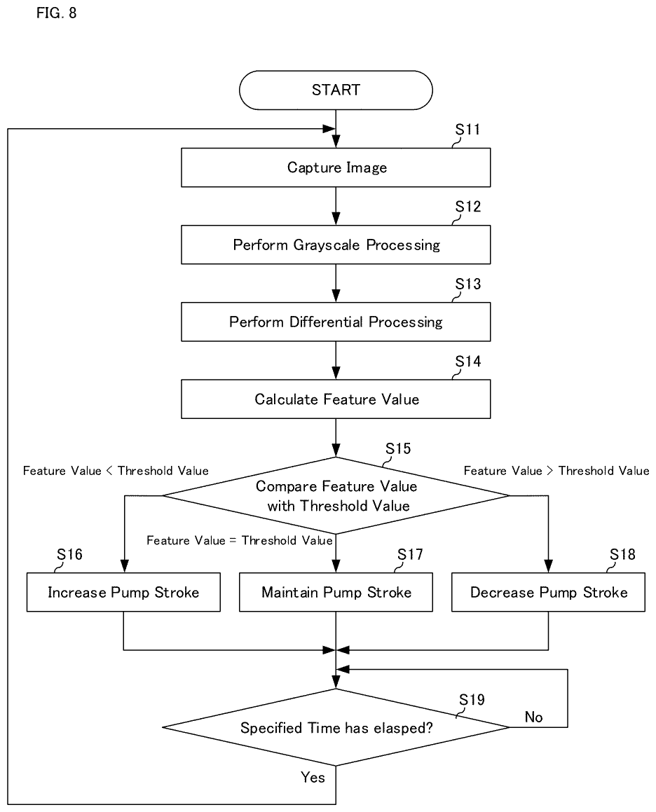

The water treatment method in the water treatment system shown in FIG. 4 will be described below. FIG. 8 is a flowchart for explaining an example of a water treatment method in the water treatment system shown in FIG. 4. Water to be treated as raw water is stored in tank 100, and a coagulant has been added into tank 100

First, imaging device 300 captures an image in tank 100, and control device 201 acquires the captured image (Step S11). Then, the grayscale processing unit 210 performs grayscale processing of the captured image in control device 201 (Step S12). Subsequently, differential processing unit 220 differentiates the numerical data that is obtained as a result of the grayscale processing performed by grayscale processing unit 210 (Step S13). Determination unit 230 then calculates the number of edge pixels as a feature value based on the result of the differential processing performed by differential processing unit 220 (Step S14). Subsequently, control signal generator 241 compares the calculated feature value with a threshold value that was set in advance (Step S15). Here, control signal generator 241 will be described with reference to a case in which the calculated feature value is compared with one threshold value that was set in advance as an example.

If the calculated feature value is less than the threshold value, control signal generator 241 generates a control signal instructing an increase of the coagulant dosage that addition device 401 injects (Step S16). For example, control signal generator 241 generates a control signal indicating a current value or a voltage value such that the coagulant dosage added by addition device 401 increase. Transmission unit 251 then transmits the control signal generated by control signal generator 241 to addition device 401.

Further, when the calculated feature value and the threshold value are the same value, control signal generator 241 generates a control signal instructing that the coagulant dosage added by addition device 401 be maintained (Step S17). For example, control signal generator 241 generates a control signal indicating a current value or a voltage value such that addition device 401 maintains the amount of the coagulant that is added. Transmission unit 251 then transmits the control signal generated by control signal generator 241 to addition device 401.

Further, when the calculated feature value is a value exceeding the threshold value, control signal generator 241 generates a control signal instructing that the coagulant dosage added by addition device 401 be reduced (Step S18). For example, control signal generator 241 generates a control signal indicating a current value or a voltage value such that the coagulant dosage added by addition device 401 is reduced. Transmission unit 251 then transmits the control signal generated by control signal generator 241 to addition device 401.

Thereafter, control device 201 determines whether a specified time has elapsed (Step S19). If it is determined that the specified time has elapsed, the process of Step S11 is performed. That is, the processing of Steps S11 to S19 are performed using the specified time as a cycle. For example, when a timer that is provided in control device 201 for measuring a specified time has timed out, control device 201 determines that the specified time has elapsed.

Incidentally, based on the comparison between the feature value and the threshold value, control device 201 may control the operation of a stirring mechanism provided in tank 100 (e.g., rotational speed, etc.).

In this way, control device 201 digitizes the grayscale of the image of tank 100 captured by imaging device 300 by performing the grayscale process. Control device 201 further performs differential processing of the digitized data, and as a result of the differential processing, calculates as the feature value the number of edge pixels that are the change points of the digitized data. Further, based on the result of the comparison between the calculated feature value and the preset threshold value, control device 201 generates a control signal for controlling the coagulant dosage added into tank 100 by addition device 401and transmits the control signal to addition device 401. Therefore, it is possible to easily monitor the aggregation state of tank 100 and to appropriately control the coagulant dosage according to the aggregation state.

### Application Example 1

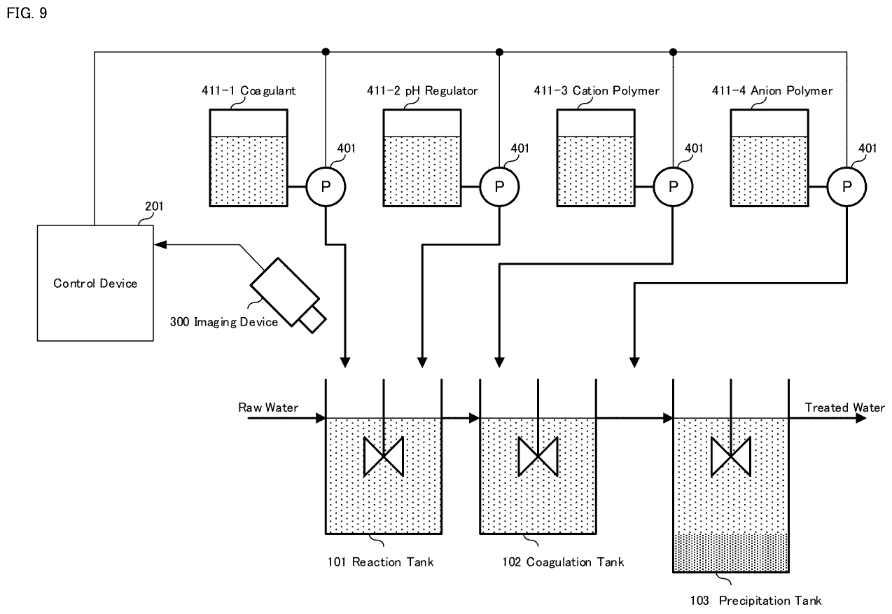

FIG. 9 is a flow diagram showing a first application example of the water treatment system of the present invention. The water treatment system shown in FIG. 9 has reaction tank 101 and coagulation tank 102 that correspond to tank 100 in the configuration mentioned above, as well as precipitation tank 103, control device 201, imaging device 300, and addition device 401 that injects a plurality of coagulants. Reaction tank 101 is a tank into which water to be treated as raw water is supplied and coagulant 411-1 and pH regulator 411-2 are added into the water to be treated using addition device 401. Coagulation tank 102 is a tank connected to an outlet of reaction tank 101 via a channel. Coagulation tank 102 is a tank in which addition device 401 is used to inject a polymer into water to be treated supplied from reaction tank 101. Further, coagulation tank 102 is a tank in which at least one of cation polymer 411-3 and anion polymer 411-4 is added. In addition, when cation polymer 411-3 is added into coagulation tank 102, anion polymer 411-4 may be added into the channel connecting precipitation tank 103 from coagulation tank 102. Precipitation tank 103 is a tank connected to an outlet of coagulation tank 102 via a channel. Precipitation tank 103 corresponds to a solid-liquid separation means for separating the aggregate and the clarified water. Each of reaction tank 101, coagulation tank 102, and precipitation tank 103 may be provided with a stirring mechanism. Control device 201, imaging device 300 and addition device 401 are each the same as those in the second embodiment.

In the water treatment system shown in FIG. 9, by injecting coagulant 411-1 into the water to be treated, minute flocs are formed from suspended matter in reaction tank 101. These minute flocs are coarsened by injecting at least one of cation polymer 411-3 and anion polymer 411-4 into coagulation tank 102. The coarsened flocs precipitate as aggregates in precipitation tank 103. As a result, the water to be treated containing the suspended matter become solid-liquid separated into aggregates and supernatant water that is clarified water. Aggregates deposited at the bottom of precipitation tank 103 are discharged as sludge. Further, the supernatant water in precipitation tank 103 is discharged as treated water.

In addition, control device 201, imaging device 300, and addition device 401 are provided in the water treatment system shown in FIG. 9, in order to monitor the state of aggregation and control the coagulant dosage, particularly coagulant 411-1. Imaging device 300 is installed above reaction tank 101 to enable capture of an image of the water in reaction tank 101. Images captured by imaging device 300 are processed by control device 201. Specific processing performed by control device 201 is as described in the second embodiment. Each of addition devices 401 control the coagulant dosage added in accordance with control signals transmitted from control device 201.

### Application Example 2

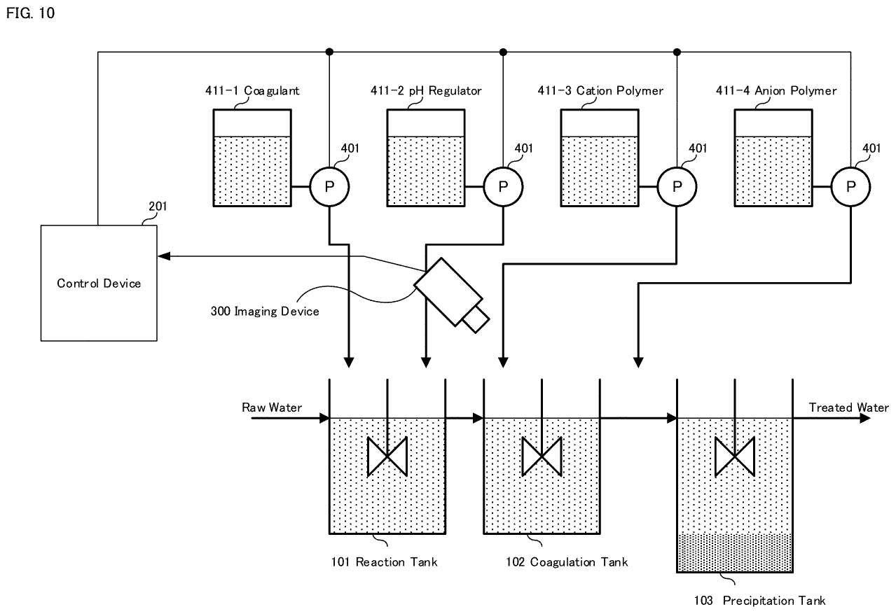

FIG. 10 is a flow diagram showing a second application example of the water treatment system of the present invention. In the water treatment system shown in FIG. 10, the difference from the water treatment system shown in FIG. 9 is the installation position of imaging device 300. In the water treatment system shown in FIG. 9, imaging device 300 is installed above reaction tank 101 to enable capture of an image of the water in reaction tank 101. On the other hand, in the water treatment system shown in FIG. 10, imaging device 300 is installed above coagulation tank 102 to enable capture of an image of the water in coagulation tank 102.

In the above-described configuration, coagulation precipitation was described, but any system that performs solid-liquid separation including coagulation may be used. For example, it is also possible to adapt the present invention to coagulation and dissolved air flotation, coagulation filtration, and the like. In addition, coagulant 411-1 added by addition device 401 to reaction tank 101 is not limited to aluminum-based (PAC, aluminum sulfate, etc.) coagulants and iron-based (polyferric sulfate, tertiary chlorinated secondary ferrous) coagulants. Also, the polymer may be a cation or an anion. If imaging device 300 is an image sensor, imaging device 300 may be installed at a position for capturing images of the inside of reaction tank 101 as in the form described above, or it may be installed at a position for capturing images of the inside of coagulation tank 102. However, considering the time lag in the tank, imaging device 300 is preferably installed at a position for capturing images of the inside of reaction tank 101. Further, when imaging device 300 is an image sensor, imaging device 300 may be a device that can determine the state of aggregation of flocs (aggregate). In this case, imaging device 300 is preferably a device that includes an apparatus for performing image processing and that can detect the number of edges of the flocs.

Although described above by allocating each function (process) to each component, these assignments are not limited to those described above. In addition, as for the configuration of the components, the above-described embodiments are merely examples, and the present invention is not limited thereto. Further, the present invention may be a combination of the embodiments.

The processing performed by each of the above-described control devices 200 and 201 may be performed by logic circuits manufactured according to the purpose. Further, a computer program (hereinafter, referred to as a “program”) in which the processing contents are described as procedures may be recorded in a recording medium that can be read by control devices 200 and 201, and the programs recorded in the recording medium may be read into and executed by control devices 200 and 201. The recording medium that can be read by control devices 200 and 201 refers to a memory or an HDD (Hard Disc Drive) such as a ROM (Read Only Memory), a RAM (Random Access Memory), or the like incorporated in control devices 200 and 201 in addition to a transferable recording medium such as a floppy (registered trademark) disk, a magneto-optical disk, a DVD (Digital Versatile Disc), a CD (Compact Disc), a Blu-ray (registered trademark) Disc, and a USB (Universal Serial Bus) memory. The program recorded in the recording medium is read by a CPU provided in each of control devices 200 and 201, and the same processing as that described above is performed under the control of the CPU. Here, the CPU operates as a computer that executes a program read from a recording medium in which a program is recorded.

While the present invention has been described with reference to the embodiments, the present invention is not limited to the above embodiments. Various changes that can be understood by those skilled in the art within the scope of the present invention can be made in the configuration and details of the present invention.

This application claims priority based on JP 2020-046476 filed on Mar. 17, 2020 and incorporates all of its disclosure herein.

1. A water treatment system, comprising:
a tank into which water to be treated flows,
an imaging device that captures an image of water into which coagulant has been added and that is stored in the tank, and
a control device that performs a grayscale processing of an image captured by that the imaging device, and a differential processing of the image that was subjected to the grayscale processing and that determines a state of the aggregates in the water based on a feature value calculated from the result of performing the differential processing.

2. The water treatment system according to claim 1, wherein
the control device performs a process of digitizing the grayscale of the image captured by the imaging device into three or more gradations as the grayscale processing.

3. The water treatment system according to claim 1 or claim 2, further comprising:
an addition device that injects the coagulant into the water to be treated, wherein
the control device generates a control signal for controlling the addition of the coagulant based on the feature value and transmits the generated control signal to the addition device, and
the addition device controls the addition of the coagulant based on the control signal transmitted from the control device.

4. The water treatment system according to claim 3, wherein
the control device compares the feature value with a preset threshold value and generates the control signal based on the result of the comparison.

5. The water treatment system according to claim 1, wherein
the control device calculates from the result of performing the differential processing the number of edge pixels or a numerical value obtained based on the number of edge pixels as the feature value.

6. The water treatment system according to claim 1, wherein
the imaging device is an infrared sensor.

7. A control device, comprising:
a grayscale processing unit that performs grayscale processing of an image captured by an imaging device of water stored in a tank,
a differential processing unit that performs differential processing of the image that has been subjected to grayscale processing by the grayscale processing unit, and
a determination unit that calculates a feature value based on the result of performing the differentiation processing and that determines the state of the aggregate in the water based on the calculated feature value.

8. The control device according to claim 7, wherein
the grayscale processing unit performs a process of digitizing the grayscale of the image captured by the imaging device into three or more gradations as the grayscale processing.

9. The control device according to claim 7 or claim 8, further comprising:
a control signal generator that generates a control signal for controlling the addition of coagulant into the water stored in the tank based on the feature value calculated by the determination unit, and
a transmission unit that transmits the control signal generated by the control signal generator to an addition device that injects the coagulant into water to be treated.

10. A water treatment method, comprising:
capturing an image of water into which coagulant has been added and that is stored in a tank into which water to be treated flows,
performing grayscale processing of the captured image,
performing differential processing of the image that has been subjected to the grayscale processing,
calculating a feature value based on the result of performing the differential processing, and
determining a state of an aggregate in the water based on the calculated feature value.

11. The water treatment method according to claim 10, wherein
the grayscale processing includes digitizing the grayscale of the captured image into three or more gradations.

12. The water treatment method according to claim 10, further comprising:
generating a control signal for controlling addition of the coagulant based on the calculated feature value, and
transmitting the generated control signal to an addition device for injecting the coagulant into water to be treated.

13. A program to make a computer execute procedures, the procedures comprising:
performing grayscale processing of an image captured by an imaging device of water stored in a tank,
performing differential processing of the image that has been subjected to the grayscale processing,
calculating a feature value based on the result of performing the differential processing, and
determining a state of an aggregate in the water based on the calculated feature value.

14. The program according to claim 13, wherein
the grayscale processing includes digitizing the grayscale of the captured image into three or more gradations.

15. The program according to claim 13, further comprising:
generating a control signal for controlling an addition of coagulant into the water stored in the tank based on the calculated feature value, and
transmitting the generated control signal to an addition device for addition of the coagulant into water to be treated.
